(19) United States
(12) Patent Application Publication
(10) Pub. No.: US 2011/0314033 A1
(43) Pub. Date: Dec. 22, 2011

(54) Derivative work discovery system and method

(75) Inventor: Omid Allen McDonald, Ottawa (CA)

(73) Assignee: Legitmix, Inc., Ottawa (CA)

(21) Appl. No.: 12/803,063

(22) Filed: Jun. 18, 2010

(51) Int. Cl. G06F 17/30; G06F 7/00

(52) U.S. Cl. 707/752; 707/803; 707/758; 707/E17.002

(57) ABSTRACT

A derivative work discovery service facilitates discovery of derivative works by consumers who request the service from a derivative work service server. The derivative work service server uses information about digital sources available on a computer system operated by the consumer to search a derivative works database. A derivative work discovery file is compiled and presented to the consumer in a descending order of a ratio of a number of digital sources possessed by the consumer that are equivalent to digital sources used to create a derivative work to a total number of digital sources used to create that derivative work.

### RELATED APPLICATIONS

This is the first application filed for this invention.

### FIELD OF THE INVENTION

This invention relates in general to the discovery of artistic works, and in particular to a computer system and method of introducing a consumer to derivative works likely to be of interest to the consumer.

### BACKGROUND OF THE INVENTION

Many different systems and methods for searching music sources and recommending music purchases are known. Examples include systems and methods that recommend music purchases based on consumer mood, perceived need, purchase history, presented sound samples, and so on.

However, none of the known systems are directed at assisting a consumer to discover derivative works likely to be of interest to them based on their possession of one or more source art works used to create a derivative work.

There therefore exists a need for derivative work discovery system and method.

### SUMMARY OF THE INVENTION

It is therefore an object of the invention to provide a derivative work discovery system and method.

The invention therefore provides a method of facilitating the discovery of derivative works by a consumer, comprising: compiling a list of digital sources available to a computer system operated by the consumer; uploading the list of digital sources to a derivative work service server; using the list of digital sources to search a derivative works database to find an identifier of each derivative work created using at least one of the digital sources; compiling a derivative work discovery file containing the identifier of each of the derivative works found by the search; performing a descending sort of the derivative work discovery file using ratio of a number of digital sources used to create the derivative work in the list of digital sources to a total number of digital sources used to create the derivative work; and presenting the sorted derivative work discovery file to the consumer.

The invention further provides a system for facilitating the discovery of derivative works by a consumer, comprising: a derivative work service server having a non-volatile memory, the derivative work service server being connected to a public network in such a way that it can be accessed by the consumer operating a computer system, the non-volatile memory storing machine-executable code that permits the consumer to log on to the derivative work service server and further permits the consumer to request the discovery of derivative works, the machine-executable code being adapted to use a list of information about digital sources found on the consumer's computer system to search a derivative works database to find an identifier of each derivative work that was created using at least one of the digital sources, and further adapted to compile a derivative work discovery file containing a record for each identifier of a derivative work found during the search; and a consumer app stored on the non-volatile memory and available for download by the consumer, the consumer app comprising machine-executable code that executes on a consumer computer system and compiles the list of information about the digital sources available on the consumer computer system and to upload the list to the derivative work service server.

The invention yet further provides a derivative work discovery file comprising at least one record containing an identifier that identifies a derivative work, an identity of each digital source used to create the derivative work, and a flag that indicates whether each of the digital sources is in a list of digital sources possessed by a consumer that initiated a derivative work discovery process to create the derivative work discovery file.

### BRIEF DESCRIPTION OF THE DRAWINGS

The embodiments of the present invention will now be described by reference to the following drawings, in which identical reference numerals in different figures indicate identical elements, and in which:

FIG. 1 is a schematic diagram of a system in accordance with one embodiment of the invention;

FIG. 2 is a flow chart characterizing principal steps of the method performed by the system in accordance with the invention;

FIG. 3 is a schematic diagram of a derivative work discovery file before it is formatted for presentation to a consumer; and

FIG. 4 is a schematic diagram of the derivative work discovery file after it is formatted for presentation to the consumer.

### DETAILED DESCRIPTION OF THE PREFERRED EMBODIMENTS

The present invention provides a derivative work discovery system and method. The derivative work discovery system facilitates discovery of derivative works by consumers who request the service from a derivative work service server. The derivative work service server uses information about digital sources available on a computer system operated by the consumer to find derivative works that are created, in whole or in part, using those digital sources. The derivative works found during the search are compiled into a derivative work discovery file. Records in the derivative work discovery file are presented to the consumer in a descending order of a ratio of a number of digital sources in the possession of the consumer that are that are equivalent to digital sources used to create the derivative work to a total number of digital sources used to create the derivative work.

### DEFINITIONS

As used herein, “source art work” means any audio work, video work, photographic work or mixed-media work in human-cognizable form which can be uniquely identified by title, artist, version, etc.

As used herein, “digital source” means a digital encoding of a source art work stored in any machine-readable format. There can be any number of digital sources for a given source art work. Each digital source inherits from the source art work it encodes all identifiers associated with that source art work (i.e., title, artist, version, etc.).

As used herein, “derivative work” means any audio work, video work, photographic work or mixed-media work derived in whole or in part from one or more digital sources.

As used herein, an “artist” means any person or combination of persons who, directly or indirectly, creates a derivative work.

As used herein, “consumer” means any person or entity that requests derivative work discovery using a consumer computer system.

As used herein, “derivative work service” means a publically accessible internet service that maintains a derivative works database and operates using machine-executable programme code to provide a derivative work discovery service to consumers.

As used herein, “Consumer app” means machine-executable programme code that permits a consumer to request derivative work discovery from the derivative work service and view derivative work discovery results.

As used herein, “derivative works database” means a collection of identifiers of derivative works and identifiers associated with each digital source used to create the respectively identified derivative works, the derivative works database being searchable using one or more of the identifiers associated with the digital sources. The derivative works database also stores a link (Universal Resource Locator) for each digital source identifier that points to a supplier of the digital source, to permit a consumer to access a worldwide web site operated by the supplier in order to purchase the digital source.

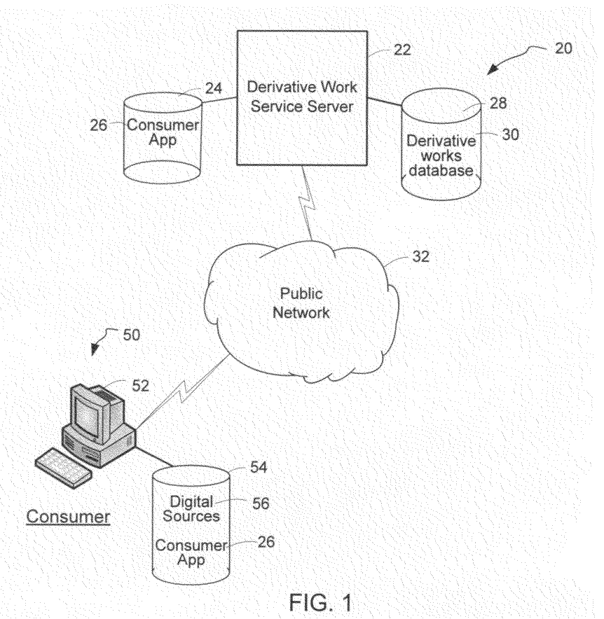

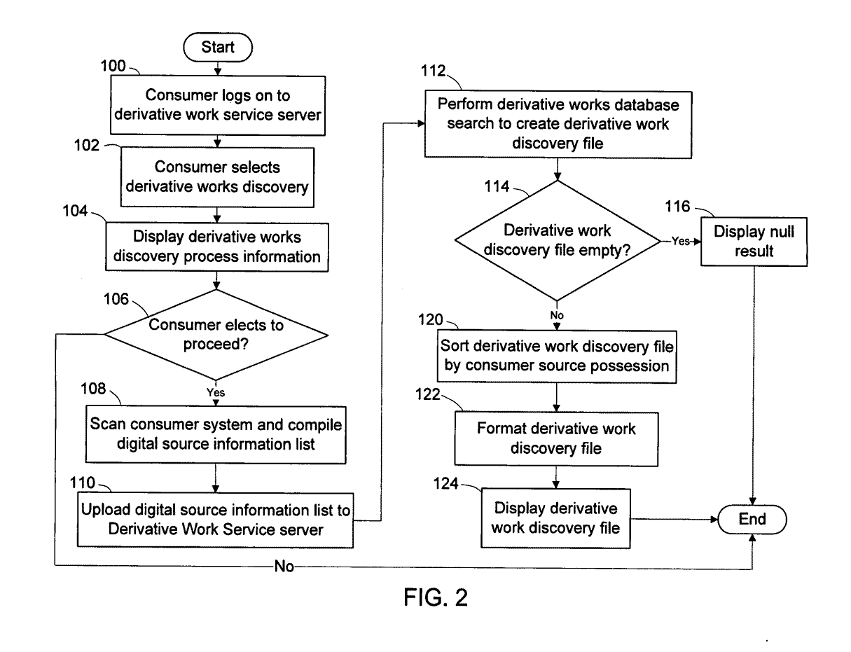

FIG. 1 is a schematic diagram of a system 20 in accordance with one embodiment of the invention. A principle component of the system 20 is a worldwide web server that supports a derivative work service in accordance with the invention, hereinafter referred to as the derivative work service server 22. The derivative work service server 22 is provisioned with non-volatile memory, such as one or more hard disks 24, 28. The non-volatile memory is used to store a Consumer app 26, the relevant functions of which will be described below in more detail with reference to FIG. 2. The Consumer app 26 is available for download by consumers via a public network 32. The non-volatile memory 26, 28 also stores a derivative works database 30. The derivative works database 30 does not store copies of any derivative works. Rather, the derivative works database 30 stores an identity of known derivative works, as well as an identity of each of the digital sources used to create the respective derivative works identified in the derivative works database, as well as a link (Universal Resource Locator) that points to a worldwide web server where the digital source can be purchased 30. The derivative works database 30 may also store associated information such as: derivative work title, mix artist name(s); cover graphics (if available); etc. The derivative works database 30 is, for example, a relational database, constructed and maintained using tools and methods that are known in the art.

Consumers 50, only one of which is shown, uses a consumer's computer system 52, a personal computer for example, having a non-volatile memory 54 to purchase, download and play or view derivative works and the digital sources used to create those derivative works in a manner well known in the art. The consumer 50 also uses the consumer's system 52 to download and execute the consumer app 26, which permits the consumer 50 to request the derivative work discovery service as described below with reference to FIG. 2.

FIG. 2 is a flow chart characterizing principal steps performed by the system 20 to assist the consumer 50 to discover derivative works likely to be of interest to them. The discovery process is initiated by the consumer 50, who has previously registered with the derivative work service using a registration function (not shown) available from the derivative work service server 22. The consumer 50 logs on (100) to the derivative work service server 20 and selects (102) a derivative works discovery option available on derivative work service menus (not shown) presented to the consumer 50 by the derivative work service server 22. When the consumer 50 selects (102) the derivative works discovery option, the derivative work service server 22 displays (104) a derivative works discovery process information page (not shown) that informs the consumer 50 that information identifying all digital sources available on the consumer's local storage device(s) 54 will be uploaded to the derivative work service server 22 in order to effect the derivative works discovery process. The derivative works discovery process information page includes a consumer-selectable option that grants permission to the derivative work service server 22 to proceed with the derivative works discovery process. After displaying the derivative works discovery process information page, the derivative work service server determines (106) if the consumer has selected the option to grant permission to proceed. If the consumer 50 does not grant permission to proceed, the process ends. However, if the consumer 50 grants permission to proceed, the derivative work service server 22 instructs the consumer app 26 to scan the local storage device(s) (e.g., non-volatile memory 54) available to the consumer system 52 in order to compile (108) a digital source information list that identifies by title, artist, version, etc. each digital source that is found on the local storage device(s) 54.

After the consumer app 26 has compiled the digital source information list, the consumer app 26 uploads (110) the digital source information list to the derivative work service server 22. In accordance with one embodiment of the invention, the digital source information list is encrypted before it is uploaded to the derivative work service server 22. Once the digital source information list has been uploaded to the derivative work service server 22, the derivative work service server 22 decrypts and/or extracts the digital source information from the digital source information list and uses the digital source information associated with each digital source identified in the digital source information list to search (112) the derivative works database 30.

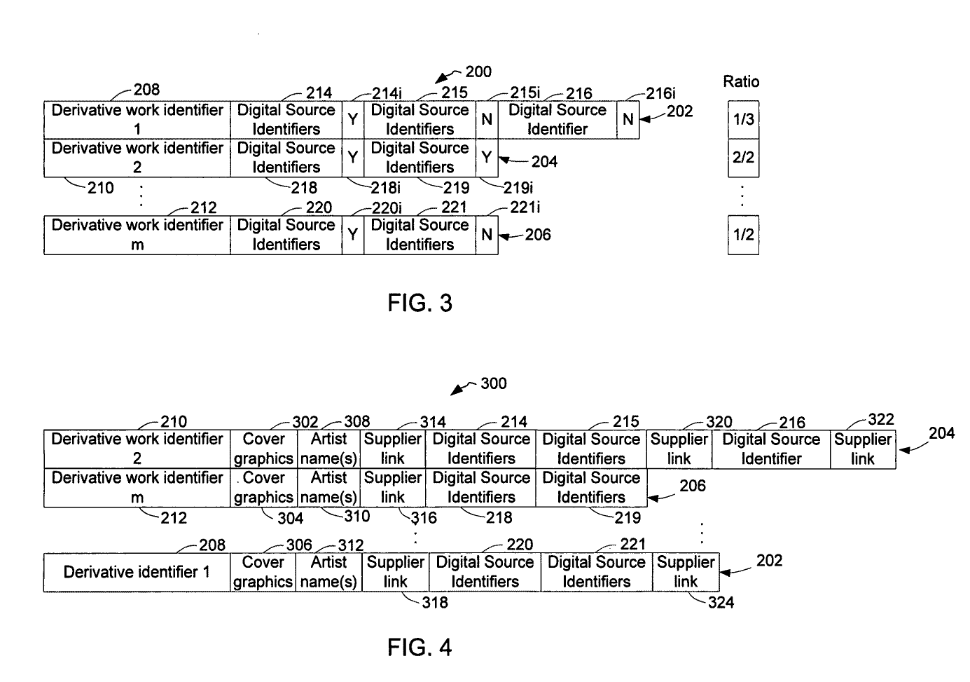

As explained above, the derivative works database 30 contains an identity of each of the digital sources used to create each of the respective derivative works identified by the derivative work identifiers stored in the derivative works database 30. If the digital source information matches one of the digital sources used by an artist to create one of the derivative works, the identifiers associated with that derivative work are used to create a new record in a derivative work discovery file created by the derivative works discovery process, as will be described below in more detail with reference to FIG. 3. The new record is also populated with the identifiers associated with each digital source used to create the derivative work. The identifiers associated with the digital source currently being used to search the derivative works database 30 are flagged to indicate that the digital source they identify is in possession of the consumer. If a record has already been created in the derivative work discovery file for the derivative work identifier, the identifiers associated with the digital source currently being used to search the derivative works database 30 are flagged to indicate that the digital source is in the possession of the consumer. As will be understood by those skilled in the art, the object of the derivative works discovery process is to create a derivative works discovery file that contains: 1) one record for each derivative work identifier found during the derivative work discovery search; 2) each record in the derivative works discovery file also includes an identity of each digital source used to create the identified derivative work; 3) an indication (flag) of whether the consumer 50 is in possession of the respective digital sources, and 3) links (Universal Resource Locators) that permit a consumer to purchase any of the digital sources used to create the identified derivative work that are not in the possession of the consumer.

After the search of the derivative works database 30 is completed (i.e., an identifier of each digital source identified in the digital source information list has been used as a key to search the derivative works database 30), the derivative work service server 22 determines (114) if the derivative work discovery file is empty. If so, a null result is displayed (116) to the consumer and the process ends. In one embodiment of the invention, the derivative work service server 22 then computes a per-record ratio of the number of digital sources identified in each record of the derivative work discovery file that are in possession of the consumer to the total number of digital sources used to create the derivative work. After the ratio is computed for each record in the derivative works discovery file, the derivative work service server 22 sorts (120) the derivative work discovery file using the ratio as a primary descending sort criteria. Any secondary or tertiary sort criteria can also be used, such as artist name/derivative work title, etc. Thus, the derivative work discovery file is sorted in a primary order in which the records are presented in accordance with a proportion of the digital sources in possession of the consumer that are the same as those digital sources used to create the respective derivative work over the total number of digital sources used to create the derivative work. In accordance with one embodiment of the invention, the derivative work service server 22 thereafter formats (122) the sorted derivative work discovery file records for presentation to the consumer 50 by, for example, appending to the respective sorted derivative work discovery file records: any available cover graphics; mix artist name(s); play duration and, optionally, a link (URL) to a supplier to permit the consumer 50 to purchase the derivative work and any of the digital source(s) required to decrypt one of the derivative works, as described in Applicant's co-pending United States patent application identified above. The derivative work service server 22 then displays (124) the formatted derivative works discovery file records for perusal by the consumer 50.

It should be noted that the consumer 50 can initiate the derivative works discovery process at any time and as often as desired.

FIG. 3 is a schematic diagram of an exemplary derivative work discovery file 200 before it is formatted for presentation to a consumer. As explained above, in accordance with one embodiment of the invention the derivative work discovery file includes a record that is created for each derivative work identified during the search of the derivative works database 30. By way of example, three records 202, 204 and 206 are shown. In one embodiment, each record contains at least the derivative work identifier 208, 210, 212 that was found during the search of the derivative works database 30. Each record 202, 204, 206 also contains an identifier of all digital source(s) used to create the derivative work and a flag to indicate whether the digital source(s) is in the possession of the consumer 50. In this example, the record 202 contains 3 digital source identifiers 214, 215 and 216. Flags (Boolean values, for example) 214i, 215i and 216i respectively indicate that the consumer is in possession of a digital source that is equivalent to the digital source (214), which is of the three digital sources used to create the derivative work identified by the derivative work identifier 208. The record 204 contains two digital source identifiers 218 and 219. The flags 218i and 219i indicate that the consumer 50 is in possession of digital sources that are respectively equivalent to each of digital sources 218 and 219 used to create the derivative work identified by the derivative work identifier 210. The record 206 contains two digital source identifiers 220 and 221, and the flags 220i and 221i indicate that the consumer 50 is in possession of one digital source that is equivalent to the digital source (220) used to create the derivative work identified by the derivative work identifier 212. As explained above, the ratio of the digital sources in the possession of the consumer 50 that are equivalent to digital sources used to create the derivative work over the total number of digital sources used to create the derivative work is computed to sort the derivative work discovery file. Although that ratio is not stored with the derivative work discovery file 300, it is shown for purposes of illustration.

FIG. 4 is a schematic diagram of a derivative work discovery file 300 after the derivative work discovery file 200 has been sorted and formatted for presentation to the consumer 50. As explained above, the derivative work discovery file 200 is sorted in descending order of the ratio of digital sources in the possession of the consumer over the total number of digital sources used to create the derivative work. Consequently, the order of the records in the sorted derivative work discovery file 300 is record 204, record 206 and record 202 (ratio respectively equals 2/2=1; 1/2=0.5; and 1/3=0.33). As also explained above, the derivative work discovery file 300 records are formatted to include, for example, cover graphics 302, 304 and 306; artist name(s) 308, 310 and 312; a supplier link, e.g. a Universal Resource Locator (URL) 314 for the derivative work identified by the derivative work identifier 210; a supplier link (URL) 316 for the derivative work identified by the derivative work identifier 212; a supplier link (URL) 318 for the derivative work identified by the derivative work identifier 208. The derivative work discovery file 300 records are also formatted to include a supplier link for each digital source that is not in the possession of the consumer 50, i.e. a supplier link (URL) 320 for the digital source identified by the digital source identifier 215; a supplier link (URL) 322 for the digital source identified by the digital source identifier 216; and, a supplier link (URL) 324 for the digital source identified by the digital source identifier 221.

It should be understood that the information associated with each derivative work identified by the derivative work discovery file records is a matter of design choice, as is the order and format for presenting that information. It should also be understood that a separate formatting step is not required and the derivative work discovery file records may be created with all information that is to be presented to the consumer. Alternatively, those records may be created with pointers to the desired information, in accordance with methods known to those skilled in the art.

The embodiments described above are therefore exemplary only of the system and method in accordance with the invention and the scope of the invention is limited solely by the scope of the appended claims.

We claim:

1. A method of facilitating the discovery of derivative works by a consumer, comprising:
compiling a list of digital sources available to a computer system operated by the consumer;
uploading the list of digital sources to a derivative work service server;
using the list of digital sources to search a derivative works database to find an identifier of each derivative work created using at least one of the digital sources;
compiling a derivative work discovery file containing the identifier of each of the derivative works found by the search;
performing a descending sort of the derivative work discovery file using ratio of a number of digital sources used to create the derivative work in the list of digital sources to a total number of digital sources used to create the derivative work; and
presenting the sorted derivative work discovery file to the consumer.

2. The method as claimed in claim 1 further comprising, prior to compiling the list of digital sources, informing the consumer of a requirement to compile and upload the list of digital sources to the derivative work service server, and requesting permission from the consumer to compile and upload the list.

3. The method as claimed in claim 1 further comprising, prior to performing the descending sort, determining if the derivative work discovery file is empty and, if the derivative work discovery file is empty, displaying a null result to the consumer.

4. The method as claimed in claim 1 wherein uploading the list of digital sources to the derivative work service server further comprises encrypting or encoding the list of digital sources prior to uploading the list of digital sources.

5. The method as claimed in claim 1 wherein compiling the derivative work discovery file comprises:
searching the derivative work discovery file for each identifier of a derivative work found; and
if the identifier is not in the derivative work discovery file, adding a record to the derivative work discovery file containing the identifier.

6. The method as claimed in claim 5 further comprising adding to the record an identity of all digital sources used to create the derivative work, and a flag to indicate that the identity of a digital source currently being used to search the derivative works database identifies a digital source that is in the possession of the consumer.

7. The method as claimed in claim 6 wherein if a record associated with the identifier of the derivative work already exists in the derivative work discovery file, the identity of the digital source currently being used to search the derivative works database is flagged to indicate that the identified digital source is in the possession of the consumer.

8. The method as claimed in claim 1 further comprising formatting the derivative work discovery file prior to presenting the derivative work discovery file to the consumer.

9. The method as claimed in claim 8 wherein formatting the derivative work discovery file comprises:
adding to each record in the derivative work discovery file any available cover graphics associated with the derivative work identified by the record; and
adding to each record in the derivative work discovery file each artist name associated with the derivative work identified by the record.

10. The method as claimed in claim 8 wherein formatting the derivative work discovery file comprises adding to each record in the derivative work discovery file a supplier link for each identified digital source associated with a flag indicating that the identified digital source is not in the possession of the consumer.

11. A system for facilitating the discovery of derivative works by a consumer, comprising:
a derivative work service server having a non-volatile memory, the derivative work service server being connected to a public network in such a way that it can be accessed by the consumer operating a computer system, the non-volatile memory storing machine-executable code that permits the consumer to log on to the derivative work service server and further permits the consumer to request the discovery of derivative works, the machine-executable code being adapted to use a list of information about digital sources found on the consumer's computer system to search a derivative works database to find an identifier of each derivative work that was created using at least one of the digital sources, and further adapted to compile a derivative work discovery file containing a record for each identifier of a derivative work found during the search; and
a consumer app stored on the non-volatile memory and available for download by the consumer, the consumer app comprising machine-executable code that executes on a consumer computer system and compiles the list of information about the digital sources available on the consumer computer system and to upload the list to the derivative work service server.

12. The system as claimed in claim 11 wherein the derivative work service server further comprises programme instructions that add to each record in the derivative works discovery file an identity of each digital source used to create the derivative work identified by the identifier contained in each record.

13. The system as claimed in claim 12 wherein the derivative work service server further comprises programme instructions that add to each record a flag associated with each identity of each digital source to indicate if the digital source is identified in the list of information about the digital sources.

14. The system as claimed in claim 12 wherein the derivative work service server further comprises programme instructions that perform a descending sort of the derivative work discovery file based on a ratio of a number of digital sources used to create a derivative work that are identified in the list of information about the digital sources to a total number of digital sources used to create the derivative work.

15. A derivative work discovery file comprising at least one record containing an identifier that identifies a derivative work, an identity of each digital source used to create the derivative work, and a flag that indicates whether each of the digital sources is in a list of digital sources possessed by a consumer that initiated a derivative work discovery process to create the derivative work discovery file.

16. The derivative work discovery file as claimed in claim 15 sorted for presentation to the consumer, wherein the records of the derivative work discovery file are sorted in a descending order of a ratio computed for each record of the number of digital sources identified by each record that are in the list of digital sources possessed by the consumer to a total number identified by the record of digital sources used to create the derivative work.

17. The derivative work discovery file as claimed in claim 15 wherein the at least one record further comprises a universal resource locator associated with the identifier that identifies the derivative work, which may be used by the consumer to access a supplier of the derivative work.

18. The derivative work discovery file as claimed in claim 15 wherein the at least one record further comprises a universal resource locator associated with the identity of each digital source that is not in the list of digital sources possessed by the consumer, which may be used by the consumer to access a supplier of the respective digital sources.

19. The derivative work discovery file as claimed in claim 15 wherein the at least one record further comprises a name of each artist that created a derivative work identified by the identifier.
